(19) United States
(12) Patent Application Publication
(10) Pub. No.: US 2010/0223930 A1
(43) Pub. Date: Sep. 9, 2010

(54) INJECTION DEVICE FOR A TURBOMACHINE

(75) Inventor: Ronald James Chila, Greer, SC (US)

Correspondence Address: CANTOR COLBURN, LLP, 20 Church Street, 22nd Floor, Hartford, CT, 06103, US

(73) Assignee: GENERAL ELECTRIC COMPANY, Schenectady, NY (US)

(21) Appl. No.: 12/399,536

(22) Filed: Mar. 6, 2009

(51) Int. Cl. F23R 3/10; F02C 3/14

(52) U.S. Cl. 60/752; 60/772

(57) ABSTRACT

A turbomachine includes a compressor, a combustor including a first end operatively connected to the compressor and a second end, a transition piece mounted to the second end of the combustor, and at least one injection device mounted to one of the combustor and the transition piece. The at least one injection device includes a first end portion that extends to a second end portion through an intermediate portion. The intermediate portion includes a flow conditioning mechanism. Combustion air from the compressor enters the first end portion passes through the flow conditioning mechanism and into the one of the combustion liner and transition piece. The flow conditioning mechanism creates an air flow disturbance in the combustion air to promote mixing of combustion gases.

### BACKGROUND OF THE INVENTION

The subject matter disclosed herein relates to the art of turbomachines and, more particularly, to an injection device for a turbomachine.

In general, gas turbine engines combust a fuel/air mixture that releases heat energy to form a high temperature gas stream. The high temperature gas stream is channeled to a turbine via a hot gas path. The turbine converts thermal energy from the high temperature gas stream to mechanical energy that rotates a turbine shaft. The turbine may be used in a variety of applications, such as for providing power to a pump or an electrical generator.

In a gas turbine, engine efficiency increases with proper combustion of an air/fuel mixture. Enhancing combustion mixing and dilution results in an enhancement of engine efficiency. Certain turbomachines employ a series of mixing and dilution passages arranged in the combustion liner. A portion of a combustion airstream passes as a jet flow into the combustion liner (or transition piece). The jet flows are employed to enhance mixing of combustion gases so as to enhance combustion efficiency, and for dilution, to enhance a profile/pattern factor of the combustion.

### BRIEF DESCRIPTION OF THE INVENTION

According to one aspect of the invention, a turbomachine includes a compressor, a combustor including a first end operatively connected to the compressor and a second end, a transition piece mounted to the second end of the combustor, and at least one injection device mounted to one of the combustor and the transition piece. The at least one injection device includes a first end portion that extends to a second end portion through an intermediate portion. The intermediate portion includes a flow conditioning mechanism. Combustion air from the compressor enters the first end portion passes through the flow conditioning mechanism and into the one of the combustion liner and transition piece. The flow conditioning mechanism creates an air flow disturbance in the combustion air to promote mixing of combustion gases.

According to another aspect of the invention, a method of injecting combustion air into a turbomachine includes generating combustion air at a compressor portion of the turbomachine, guiding the combustion air to at least one injection device mounted to one of a combustor and a transition piece portion of the turbomachine, passing the combustion air into a first end portion of the at least one injection device, guiding the combustion air through a flow conditioning mechanism arranged in the at least one injection device to establish a conditioned combustion air flow, and directing the conditioned combustion air flow into the one of the combustor and the transition piece.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a partial cross-sectional view of a turbomachine including an injection device in accordance with an exemplary embodiment;

FIG. 2 is partial, cross-sectional view of a combustor portion of the turbomachine of FIG. 1;

FIG. 3 is a bottom right perspective view of an injection device in accordance with an exemplary embodiment;

FIG. 4 is a top right perspective view of the injection device of FIG. 3; and

FIG. 5 is cross-sectional side view of the injection device of FIG. 3.

The detailed description explains embodiments of the invention, together with advantages and features, by way of example with reference to the drawings.

### DETAILED DESCRIPTION OF THE INVENTION

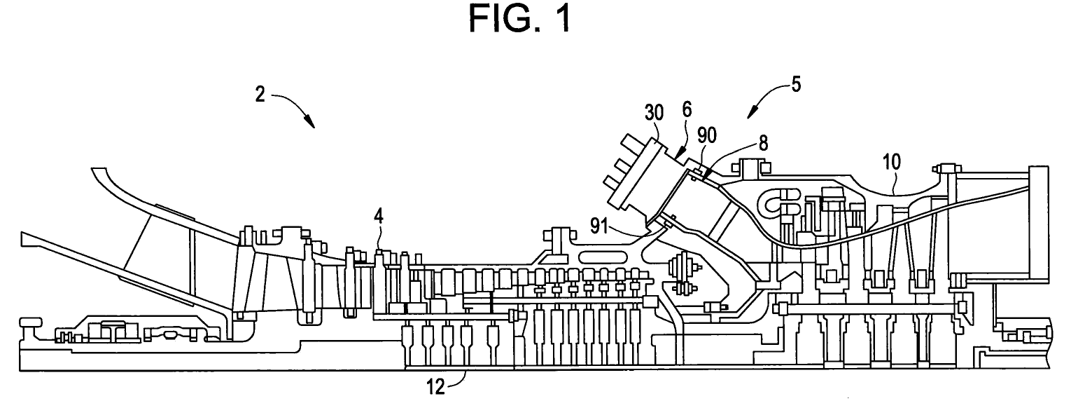

With reference to FIG. 1, a turbomachine constructed in accordance with exemplary embodiments of the invention is generally indicated at 2. Turbomachine 2 includes a compressor 4 and a combustor assembly 5 having at least one combustor 6 provided with an injection nozzle assembly housing 8. Turbomachine 2 also includes a turbine 10 and a common compressor/turbine shaft 12. Notably, the present invention is not limited to any one particular engine and may be used in connection with other turbomachines.

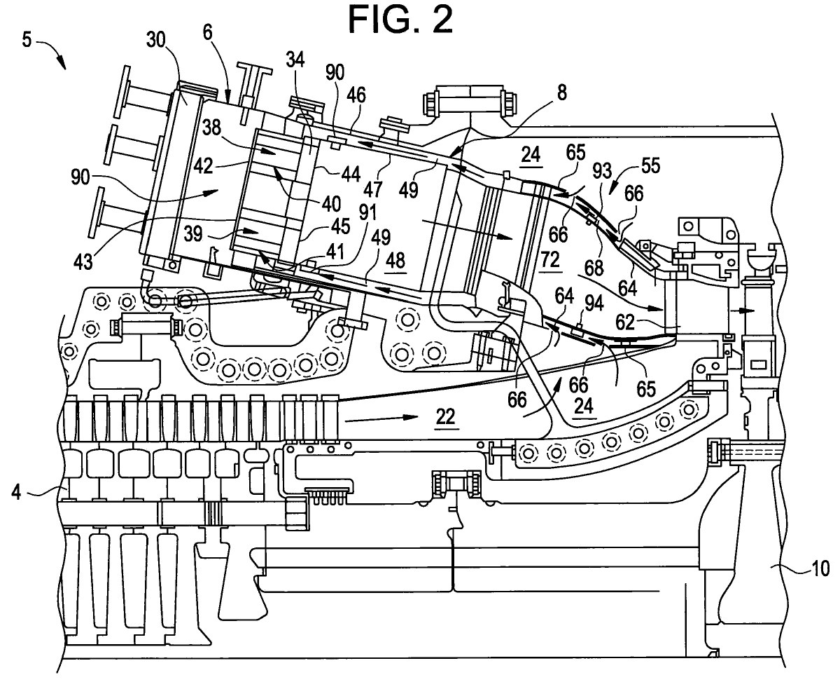

As best shown in FIG. 2, combustor 6 is coupled in flow communication with compressor 4 and turbine 10. Compressor 4 includes a diffuser 22 and a compressor discharge plenum 24 that are coupled in flow communication with each other. Combustor 6 also includes an end cover 30 positioned at a first end thereof, and a cap member 34. Combustor 6 further includes a plurality of pre-mixers or injection nozzle assemblies, two of which are indicated at 38 and 39. In addition, combustor 6 includes a combustor casing 46 and a combustor liner 47. As shown, combustor liner 47 is positioned radially inward from combustor casing 46 so as to define a combustion chamber 48. An annular combustion chamber cooling passage 49 is defined between combustor casing 46 and combustor liner 47. Combustor 6 is coupled to turbomachine 2 through a transition piece 55. Transition piece 55 channels combustion gases generated in combustion chamber 48 downstream towards a first stage turbine nozzle 62. Towards that end, transition piece 55 includes an inner wall 64 and an outer wall 65. Outer wall 65 includes a plurality of openings 66 that lead to an annular passage 68 defined between inner wall 64 and outer wall 65. Inner wall 64 defines a guide cavity 72 that extends between combustion chamber 48 and turbine 10.

During operation, air flows through compressor 4, is compressed, and passed to combustor 6 and, more specifically, to injector assemblies 38 and 39. At the same time, fuel is passed to injector assemblies 38 and 39 to mix with the compressed air to form a combustible mixture. The combustible mixture is channeled to combustion chamber 48 and ignited to form combustion gases. The combustion gases are then channeled to turbine 10. Thermal energy from the combustion gases is converted to mechanical rotational energy that is employed to drive compressor/turbine shaft 12.

More specifically, turbine 10 drives compressor 4 via compressor/turbine shaft 12 (shown in FIG. 1). As compressor 4 rotates, compressed air is discharged into diffuser 22 as indicated by associated arrows. In the exemplary embodiment, a majority of the compressed air discharged from compressor 4 is channeled through compressor discharge plenum 24 towards combustor 6. Any remaining compressed air is channeled for use in cooling engine components. Compressed air within discharge plenum 24 is channeled into transition piece 55 via outer wall openings 66 and into annular passage 68. The compressed air is then channeled from annular passage 68 through annular combustion chamber cooling passage 49 and to injection nozzle assemblies 38 and 39. The fuel and air are mixed to form the combustible mixture. The combustible mixture is ignited to form combustion gases within combustion chamber 48. Combustor casing 47 facilitates shielding combustion chamber 48 and its associated combustion processes from the outside environment such as, for example, surrounding turbine components. The combustion gases are channeled from combustion chamber 48 through guide cavity 72 and towards turbine nozzle 62. The hot gases impacting first stage turbine nozzle 62 create a rotational force that ultimately produces work from turbomachine 2. At this point it should be understood that the above-described construction is presented for a more complete understanding of exemplary embodiments of the invention.

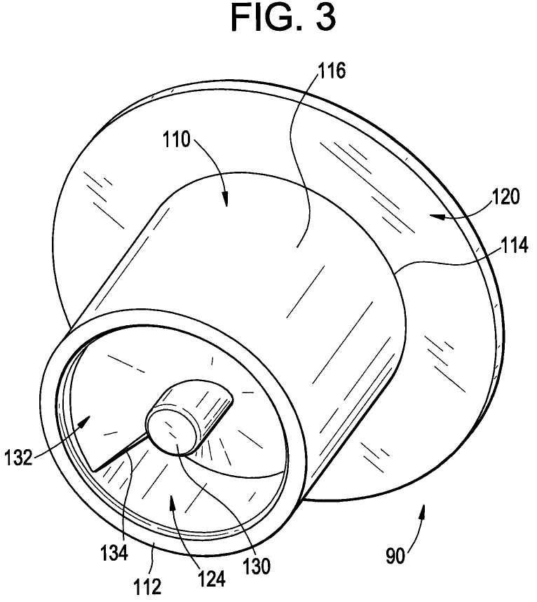

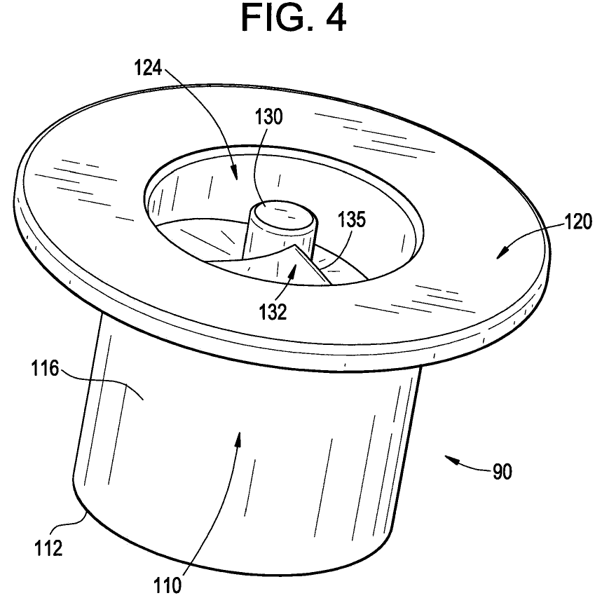

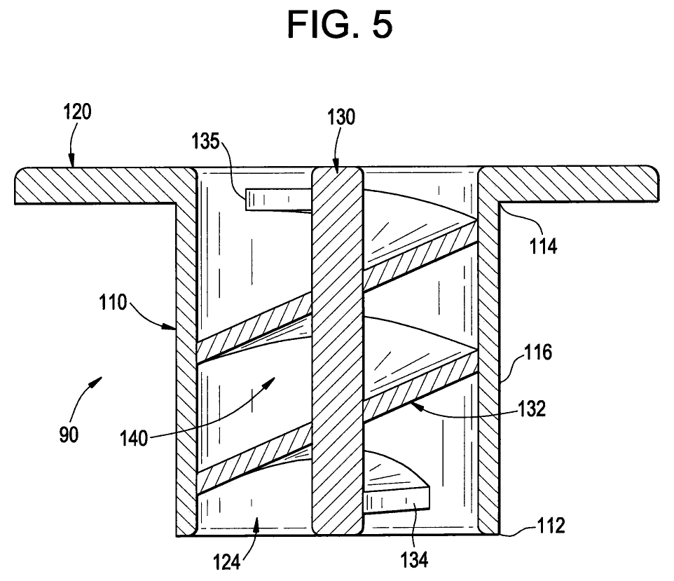

In order to enhance combustion efficiency, turbomachine 2 includes a plurality of injection devices 90, 91 and 93, 94. Injection devices 90 and 91 are mounted to combustion liner 47 and are arranged so as to enhance mixing of combustion gases in combustion chamber 48, while injection devices 93 and 94 are arranged on inner wall 64 of transition piece 55 and are arranged so as to facilitate dilution of the combustion gases passing into first turbine stage 62. As each injection device 90, 91 and 93, 94 is similarly constructed, reference will now be made to FIGS. 3-5 in describing injection device 90 with an understanding that the remaining injection devices 91, 93 and 94 are similarly formed.

In accordance with the exemplary embodiment shown, injection device 90 includes a main body 110 having a first end portion 112 that extends to a second end portion 114 through an intermediate portion 116. A circular flange 120 is mounted to second end portion 114. Flange 120 provides structure to secure injection device 90 to turbomachine 2. More specifically, flange 120 is welded, or otherwise attached to, for example, combustion liner 47 so that main body 110 projects into combustion chamber 48. Alternatively, flange 120 is welded or otherwise attached to transition piece 55 such that main body 110 projects into guide cavity 72. As noted above, the particular location of injection device 90 depends upon design parameters as well as desired mixing attributes.

In further accordance with the exemplary embodiment, injection device 90 includes a flow conditioning mechanism 124. Flow conditioning mechanism 124 is configured to create a disturbance in combustion air passing through injection device 90. In the exemplary embodiment shown, flow conditioning mechanism 124 includes a central, axial post 130 about which extends a turbulator member 132. Turbulator member 132 includes a first end 134 that extends to a second end 135 along a helical flow path 140. Helical flow path 140 extends between first and second end portions of main body 110. With this arrangement, air entering injection device 90 passes along helical flow path 140. Helical flow path 140 initiates a disturbance that establishes a swirled airflow. The swirled airflow is then passed into combustion chamber 48 to facilitate additional mixing of combustion gases contained therein. Alternatively, the swirled airflow is passed into guide cavity 72 to increase dilution of the combustion gases and further enhance efficiency.

At this point it should be understood that while the exemplary embodiment depicts the flow conditioning mechanism as having a helical flow path, various other geometries may also be employed. That is, the flow conditioning mechanism may include concentric rings, raised ridges or other forms of protuberances, and or recesses that impart a disturbance to the air flow. In addition, it should be understood that the particular location and mounting of the injection device can vary depending upon design parameters and desired flow characteristics.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A turbomachine comprising:
a compressor;
a combustor including a first end operatively connected to the compressor and a second end;
a transition piece mounted to the second end of the combustor; and
at least one injection device mounted to one of the combustor and the transition piece, the at least one injection device including a first end portion that extends to a second end portion through an intermediate portion, the intermediate portion including a flow conditioning mechanism, wherein combustion air from the compressor enters the first end portion passes through the flow conditioning mechanism and into the one of the combustion liner and transition piece, the flow conditioning mechanism creating an air flow disturbance in the combustion air to promote mixing of combustion gases.

2. The turbomachine according to claim 1, wherein the flow conditioning mechanism is a turbulator mounted within the at least one injection device.

3. The turbomachine according to claim 2, wherein the turbulator includes a helical flow path.

4. The turbomachine according to claim 1, wherein the at least one injection deice is mounted to the combustor.

5. The turbomachine according to claim 1, wherein the at least one injection device is mounted to the transition piece.

6. The turbomachine according to claim 1, wherein the at least one injection device comprises a plurality of injection devices arranged along the one of the combustor and the transition piece.

7. The turbomachine according to claim 1, wherein the first end portion of the at least one injection device includes a flange.

8. The turbomachine according to claim 1, wherein the at least one injection device is welded to the one of the combustor and the transition piece.

9. The turbomachine according to claim 1, further comprising: a combustion liner mounted within the combustor, the at least one injection device being mounted to the combustion liner.

10. A method of injecting combustion air into a turbomachine, the method comprising:
generating combustion air at a compressor portion of the turbomachine;
guiding the combustion air to at least one injection device mounted to one of a combustor and a transition piece portion of the turbomachine;
passing the combustion air into a first end portion of the at least one injection device;
guiding the combustion air through a flow conditioning mechanism arranged in the at least one injection device to establish a conditioned combustion air flow; and
directing the conditioned combustion air flow into the one of the combustor and the transition piece.

11. The method of claim 10, wherein guiding the combustion air through the flow conditioning mechanism comprises passing the combustion air flow through a turbulator member arranged within the at least one injection device.

12. The method of claim 11, wherein passing the combustion air flow through a turbulator member comprises flowing the combustion air flow along a helical flow path, the helical flow path swirling the combustion air flow.

13. The method of claim 10, wherein directing the conditioned combustion air flow into the one of the combustor and the transition piece includes directing the conditioned combustion air into the combustor.

14. The method of claim 13, wherein directing the conditioned combustion air flow into the combustor comprises directing the conditioned combustion air through a combustion liner portion of the combustor.

15. The method of claim 10, wherein directing the conditioned combustion air flow into the one of the combustor and the transition piece comprises directing the conditioned combustion air into the transition piece.

16. The method of claim 10, wherein passing the combustion air into at least one injection device comprises passing the combustion air into a plurality of injection devices mounted to the one of the combustor and the transition piece.
